(19) United States
(12) Patent Application Publication
(10) Pub. No.: US 2025/0157222 A1
(43) Pub. Date: May 15, 2025

(54) INFORMATION PROCESSING DEVICE AND CONGESTION INFORMATION GENERATION METHOD

(71) Applicant: Sharp NEC Display Solutions, Ltd., Tokyo (JP)

(72) Inventor: Masatoshi ABE, Minato-ku, Tokyo (JP)

(21) Appl. No.: 18/834,537

(22) PCT Filed: Mar. 23, 2022
(86) PCT No.: PCT/JP2022/013532

§ 371 Date: Jul. 30, 2024

(51) Int. Cl. G06V 20/52; G06V 20/59

(52) U.S. Cl. CPC G06V 20/53; G06V 20/59; G06V 2201/07

(57) ABSTRACT

An information processing device includes: a car identifying unit identifying a target car that a passenger gets on, in accordance with a departure station and a destination station of the passenger using a car, and with time point information, the car being provided with a plurality of boarding doors; and a congestion information generating unit generating congestion information indicating a degree of congestion of interior areas each associated with one or a plurality of boarding doors of the target car running from the departure station to the destination station.

### TECHNICAL FIELD

The present invention relates to an information processing device and a congestion information generation method that generate congestion information on a car.

### BACKGROUND ART

There are conventional techniques proposed to output congestion information on vehicles. For example, Patent Document 1 discloses a congestion information output method for providing passengers of a vehicle with information indicating a congestion degree. The invention disclosed in Patent Document 1 is to provide congestion information, so as to encourage the passengers to use the vehicle at off-peak hours to reduce congestion.

### CITATION LIST

### Patent Literature

Patent Document 1: Japanese Patent No. 6295505

### SUMMARY OF INVENTION

### Technical Problems

However, some passengers cannot always change vehicles to get on. That is, even if a passenger has obtained congestion information, he or she might have no choice but to get on a crowded vehicle. As a result, the invention disclosed in Patent Document 1 could not always reduce congestion.

The present disclosure is devised in view of the above problems. The present disclosure sets out to provide an information processing device and a congestion information generation method that allow a passenger of a car to readily avoid congestion without changing a car that the passenger is scheduled to get on.

### Solution to Problems

An aspect of the present disclosure provides an information processing device including: a car identifying unit that identifies a target car that a passenger gets on, in accordance with a departure station and a destination station of the passenger using a car, and with time point information, the car being provided with a plurality of boarding doors; and a congestion information generating unit that generates congestion information indicating a degree of congestion of interior areas each associated with one or a plurality of boarding doors of the target car running from the departure station to the destination station.

Another aspect of the present disclosure provides a congestion information generation method executed by an information processing device. The congestion information generation method includes: a step of identifying a target car that a passenger gets on, in accordance with a destination station and a departure station of the passenger using a car, and with time point information, the car being provided with a plurality of boarding doors; and a step of generating congestion information indicating a degree of congestion of interior areas each associated with one or a plurality of boarding doors of the target car running from the departure station to the destination station.

### BRIEF DESCRIPTION OF DRAWINGS

FIG. 1 is a functional block diagram illustrating a schematic configuration of a congestion information generation system according to a first embodiment.

FIG. 2 is a sequence diagram showing an example of processing carried out by the congestion information generation system in FIG. 1.

FIG. 3 is a flowchart showing an example of congestion information generation processing executed by a control unit of the information processing device in FIG. 1.

FIG. 4 is a flowchart showing an example of processing executed by a congestion information generating unit in FIG. 1.

FIG. 5 is a schematic diagram illustrating a correspondence relationship between an interior area and boarding doors.

FIG. 6 is a diagram illustrating an example of congestion information displayed on a display unit in FIG. 1.

FIG. 7 is a functional block diagram illustrating a schematic configuration of a congestion information generation system according to a second embodiment.

FIG. 8 is a sequence diagram showing an example of processing carried out by the congestion information generation system in FIG. 7.

### DESCRIPTION OF EMBODIMENTS

Embodiments of the present disclosure will now be described, with reference to the drawings. Note that like reference signs designate identical or corresponding components throughout the drawings. Such components will not be repeatedly elaborated upon.

### First Embodiment

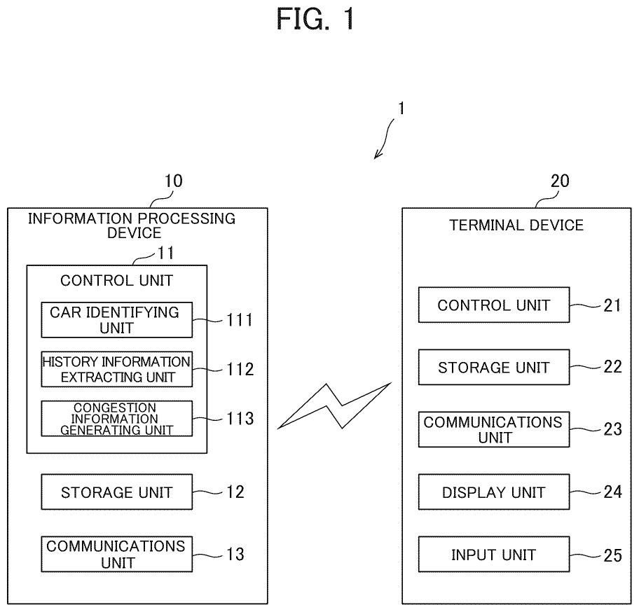

FIG. 1 is a functional block diagram illustrating a schematic configuration of a congestion information generation system 1 according to a first embodiment. As illustrated in FIG. 1, the congestion information generation system 1 according to the first embodiment includes: an information processing device 10; and a terminal device 20. The information processing device 10 and the terminal device 20 are communicably connected together so as to exchange information through, for example, wire communications or wireless communications.

The information processing device 10 can carry out a congestion information generation method for generating congestion information. In this description, the congestion information indicates a congestion degree of each of the interior areas of a car provided with a plurality of boarding doors. Each interior area is a region inside the car, and the region is associated with a boarding door. One interior area is associated with one or a plurality of boarding doors. The interior area may be set as a specific region including, for example, one or a plurality of boarding doors. The interior area is preferably set as a region where a passenger who gets on the car at a certain boarding door is likely to be located in the car. Hence, the interior area may be set to include, for example, an area around the boarding door. The interior area may be set as a region in the car from one boarding door to another boarding door adjacent to the one boarding door. The interior area may also be set as the whole interior of one car provided with a boarding door.

The information processing device 10 may generate, for example, congestion information from a departure station to a destination station for a passenger using the car. Note that the departure station is a station where the passenger gets on the car. The destination station is a station where the passenger gets off the car. The information processing device 10 may transmit the generated congestion information to, for example, the terminal device 20.

In this description, the car may be any given vehicle provided with a plurality of boarding doors. Here, the statement “provided with a plurality of boarding doors” means that one car may be provided with a plurality of boarding doors. However, one car does not have to be necessarily provided with a plurality of boarding doors. That is, the statement “provided with a plurality of boarding doors” means that, if a plurality of cars are coupled together to constitute one car-set to operate, the statement includes cases where each of the plurality of cars may be provided with only one boarding door and where the whole one car-set is provided with a plurality of boarding doors. For example, assume a case where one car is provided with only one boarding door. If two or more of such cars are coupled together to constitute one car-set to operate, it can be understood that the one car-set as a whole, including the coupled two or more cars, is provided with a plurality of boarding doors.

The cars may be, for example, but not limited to, trains. For example, other vehicles such as buses are also included in “cars” in this description.

The information processing device 10 can be, for example, a computer or a server device. As illustrated in, for example, FIG. 1, the information processing device 10 may include functional blocks such as: a control unit 11; a storage unit 12; and a communications unit 13.

The control unit 11 controls and manages the whole information processing device 10 including the functional units of the information processing device 10. The control unit 11 runs, for example, an information processing program stored in the storage unit 12 to carry out various kinds of control. For example, the control unit 11 can be such a control device as a central processing unit (CPU) or a micro processing unit (MPU). The control unit 11 executes congestion information generation processing to generate congestion information.

As illustrated in, for example, FIG. 1, the control unit 11 may include: a car identifying unit 111; a history information extracting unit 112; and a congestion information generating unit 113, as functional blocks executing the congestion information generation processing. Each of the car identifying unit 111, the history information extracting unit 112, and the congestion information generating unit 113 may be an independent control device (e.g., a CPU or an MPU). Alternatively, one control device may collectively execute functions executed by the car identifying unit 111, the history information extracting unit 112, and the congestion information generating unit 113. The congestion information generation processing may be executed by the car identifying unit 111, the history information extracting unit 112, and the congestion information generating unit 113.

The car identifying unit 111 identifies a car (hereinafter also simply referred to as a “target car”) that the passenger gets on. The car identifying unit 111 identifies the target car in accordance, for example, with the departure station and the destination station of the passenger, and with time point information. Here, the car identifying unit 111 may identify the target car with reference to, for example, an operation schedule such as a diagram. The operation schedule may include, for example, information on a time point at which the cars depart from each of the stations. The operation schedule may be, for example, either stored in the storage unit 12, or obtained through the communications unit 13 from an external device storing the operation schedule.

The history information extracting unit 112 extracts, from boarding history information, target car history information on the target car. The boarding history information indicates either a past on-board passenger count or a past boarding passenger count between stops of a car in operation. Here, the on-board passenger count indicates a count of passengers on board; that is, a count of passengers found in the car. Moreover, the boarding passenger count indicates a count of passengers who get on the car; that is, for example, a count of passengers who get on the car at a platform. In this embodiment, the boarding history information is described as the past on-board passenger count. However, even if the boarding history information is the past boarding passenger count, the congestion information can be generated, using the same technique as that described in this embodiment.

The boarding history information may indicate a past on-board passenger count in each of the interior areas between the stops. The boarding history information may include information indicating past on-board passenger counts between all the stops for all the cars operated on the operation schedule. Out of the boarding history information including information on all the cars, the history information extracting unit 112 extracts information on the target car in a form of the target car history information. The boarding history information may be, for example, either stored in the storage unit 12, or obtained through the communications unit 13 from an external device storing the boarding history information.

The congestion information generating unit 113 generates congestion information on interior areas each associated with one or a plurality of boarding doors of the target car running from the departure station to the destination station of the passenger. The congestion information generating unit 113 may generate the congestion information in accordance with, for example, the target car history information extracted by the history information extracting unit 112. The congestion information generating unit 113 may obtain boarding-and-alighting passenger count information on a boarding-and-alighting passenger count for each of the boarding doors of the target car at stops from the departure station to the destination station, using, for example, the target car history information. The congestion information generating unit 113 may generate the congestion information in accordance with the obtained boarding-and-alighting passenger count information and with the on-board passenger count of the passengers on board in each of the interior areas associated with one or a plurality of boarding doors of the target car.

The congestion information generation processing executed by the car identifying unit 111, the history information extracting unit 112, and the congestion information generating unit 113 will be described later in detail.

The storage unit 12 is a storage medium capable of storing programs and data. The storage unit 12 can be, for example, a semiconductor memory or a magnetic memory. Specifically, the storage unit 12 can be, for example, an electrically erasable programmable read-only memory (EEPROM). The storage unit 12 may store, for example, a program for operating the control unit 11. Specifically, the storage unit 12 may store, for example, an information processing program to execute the congestion information generation processing described in this description. Furthermore, the storage unit 12 may store information to be used for the congestion information generation processing, and the information may include, for example, the operation schedule and the boarding history information.

The communications unit 13 executes communications, and exchanges information, with an external device. In this embodiment, the communications unit 13 executes communications, and exchanges information, with, for example, the terminal device 20. The communications unit 13 may execute communications, and exchange information, through, for example, wire communications or wireless communications. The communications unit 13 transmits and receives various kinds of information through communications. For example, in this embodiment, the communications unit 13 transmits to the terminal device 20 the congestion information generated by the control unit 11.

The terminal device 20 is an example of an external display device that communicates with the information processing device 10. The terminal device 20 is used by a passenger. The passenger can request the congestion information on the terminal device 20, through, for example, a website or an application for obtaining the congestion information from the information processing device 10. The information processing device 10 generates the congestion information in response to the request, and transmits the generated congestion information to the terminal device 20. The terminal device 20 displays the congestion information received from the information processing device 10, thereby successfully providing the congestion information to the passenger.

The terminal device 20 can be, for example, a mobile terminal such as a smartphone, a tablet terminal, or a personal computer. As illustrated in, for example, FIG. 1, the terminal device 20 may include functional blocks such as: a control unit 21; a storage unit 22; a communications unit 23; a display unit 24; and an input unit 25.

The control unit 21 controls and manages the whole terminal device 20 including the functional units of the terminal device 20. The control unit 21 runs, for example, an information processing program stored in the storage unit 22 to carry out various kinds of control. For example, the control unit 21 can be such a control device as a CPU or an MPU. The control unit 21 requests the information processing device 10 for the congestion information in accordance with, for example, an operational input carried out by the passenger to the input unit 25. Furthermore, the control unit 21 causes the display unit 24 to display the congestion information received from the information processing device 10.

The storage unit 22 is a storage medium capable of storing programs and data. The storage unit 22 can be, for example, a semiconductor memory or a magnetic memory. Specifically, the storage unit 22 can be, for example, an EEPROM. The storage unit 22 may store, for example, a program for operating the control unit 21.

The communications unit 23 executes communications, and exchanges information, with an external device. In this embodiment, the communications unit 23 executes communications, and exchanges information, with, for example, the information processing device 10. The communications unit 23 may execute communications, and exchange information, through, for example, wire communications or wireless communications. The communications unit 23 transmits and receives various kinds of information through communications. For example, in this embodiment, the communications unit 23 transmits to the information processing device 10 a signal that requests for the congestion information. For example, in this embodiment, the communications unit 23 receives the congestion information transmitted by the information processing device 10.

The display unit 24 is a device that displays a video. The display unit 24 may be a well-known display such as a liquid crystal display (LCD), an organic electro-luminescence display (OELD), or an inorganic electro-luminescence display (IELD). The display unit 24 is controlled by the control unit 21 to display various kinds of information. For example, the display unit 24 displays the congestion information that the terminal device 20 has obtained from the information processing device 10.

The input unit 25 is a mechanism capable of receiving the operational input of the passenger to the terminal device 20. The input unit 25 may be, for example, a group of operation buttons provided to a main body of the terminal device 20. The input unit 25 may be, for example, a remote control device (hereinafter also simply referred to as a “remote controller”) and an operation signal receiving unit that receives an operation signal transmitted from the remote controller. Note that if the display unit 24 is provided with a touch sensor, the touch sensor provided to the display unit 24 may function as the input unit 25.

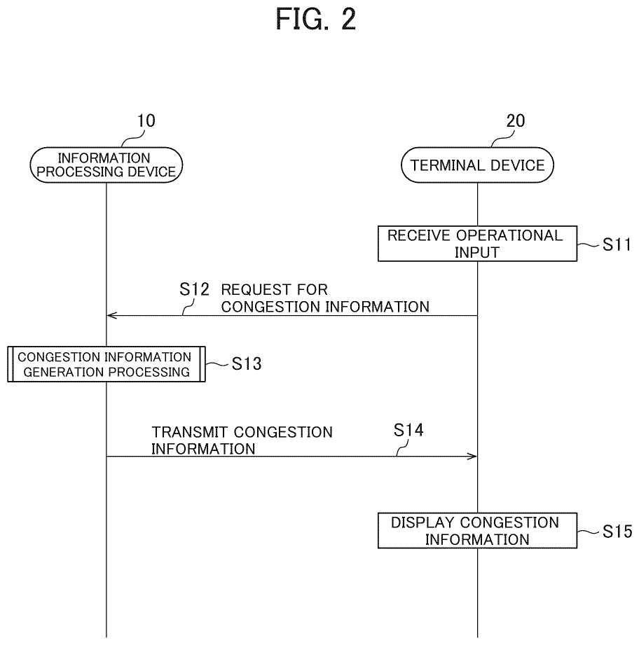

Described next will be an example of processing carried out by the congestion information generation system 1. FIG. 2 is a sequence diagram showing an example of processing carried out by the congestion information generation system 1 in FIG. 1.

When a passenger would like to check the congestion information, he or she carries out a predetermined operational input to the terminal device 20 using the input unit 25. The terminal device 20 receives the operational input carried out by the passenger (Step S11). Specifically, the passenger carries out, for example, an operational input to the input unit 25 to obtain the congestion information.

Here, the terminal device 20 may obtain information on a section for which the passenger uses a car. For example, the terminal device 20 may receive an input as to the departure station and the destination station to obtain the information on the section for which the passenger uses the car. Furthermore, the terminal device 20 may obtain time point information. The time point information is information on a time point at which the passenger uses the car. The time point information may be determined in accordance with an input by the passenger. For example, the terminal device 20 may obtain the time point information by receiving an input of either a time point at which the passenger desires to get on the car at the departure station or a time point at which the passenger desires to arrive at the destination station. Alternatively, the terminal device 20 may obtain a current time point as the time point information. For example, if the passenger has already arrived at the departure station and intends to use the car now, he or she may carry out an operational input to designate the current time point. In this case, the terminal device 20 obtains the current time point as the time point information.

In accordance with the operational input by the passenger, the terminal device 20 transmits, to the information processing device 10, a signal for requesting for congestion information (Step S12). This signal may include the obtained departure station, destination station, and time point information.

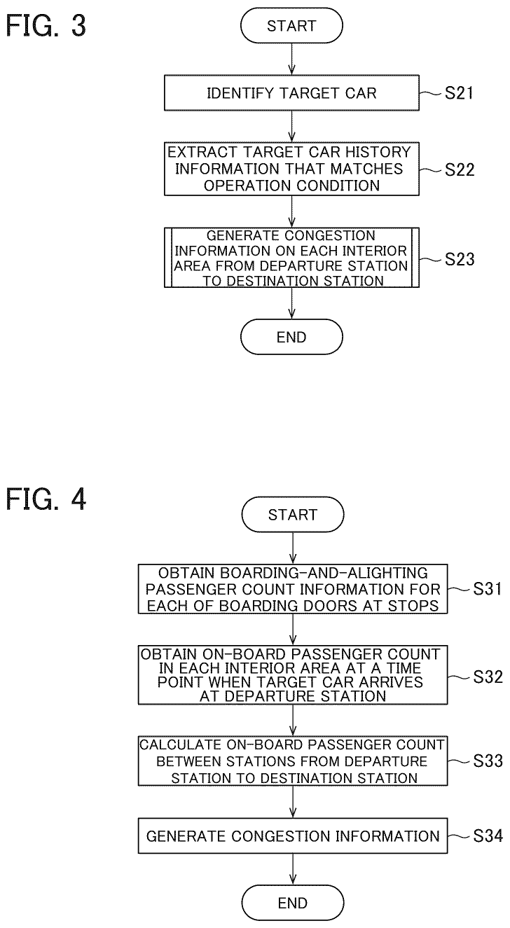

Upon receiving, from the terminal device 20, the signal for requesting the congestion information, the information processing device 10 executes the congestion information generation processing in accordance with the signal (Step S13). The information processing device 10 executes the congestion information generation processing to generate the congestion information. The congestion information generation processing will be described in detail later in the description with reference to FIG. 3.

The information processing device 10 transmits the generated congestion information to the terminal device 20 (Step S14).

Upon receiving the congestion information from the information processing device 10, the terminal device 20 displays the received congestion information on the display unit 24 (Step S15). The passenger checks the congestion information displayed on the display unit 24, and successfully understands a congestion degree of each of the interior areas of the target car from the departure station to the destination station.

Described next will be the details of the congestion information generation processing to be executed by the information processing device 10. FIG. 3 is a flowchart showing an example of the congestion information generation processing executed by the control unit 11 of the information processing device 10. That is, FIG. 3 is a flowchart showing the details of Step S13 in FIG. 2.

As described with reference to FIG. 2, the information processing device 10 receives, from the terminal device 20, the signal for requesting for the congestion information. Then, the information processing device 10 executes the congestion information generation processing. Here, as an example, it is assumed that, at Step S11 in FIG. 2, the passenger inputs: Station A as the departure station; Station D as the destination station; and a departure time point 10:00 AM of the car departing from the departure station as the time point information. In this case, the signal transmitted at Step S12 includes information indicating that the departure station is Station A and the destination station is Station D, and the time point information indicating that the car departs from the departure station at 10:00 AM.

In the congestion information generation processing, first, the control unit 11 causes the car identifying unit 111 to identify the target car (Step S21). Specifically, the car identifying unit 111 identifies the target car with reference to an operation schedule of cars, in accordance with the departure station, the destination station, and the time point information received from the terminal device 20. That is, with reference to the operation schedule, the car identifying unit 111 identifies a car that departs from Station A at 10:00 AM and stops at Station D.

As seen in this example, assume a case where the time point information indicates a specific time point of departure from the departure station. If there is no car departing from the departure station precisely at the specific time point, the car identifying unit 111 may identify, as the target car, a car that departs from the departure station at around the specific time point. The same applies to a case where the time point information indicates a time point of arrival at the destination station.

Hence, in this example, if the operation schedule has no car that departs from Station A at 10:00 AM and stops at Station D, the car identifying unit 111 may identify, as the target car, a car that departs from Station A at around 10:00 AM and stops at station D.

Next, the control unit 11 causes the history information extracting unit 112 to extract target car history information that matches an operation condition. Specifically, the history information extracting unit 112 extracts, from the information history information, the target car history information that matches operation information.

Here, the boarding history information indicates a past on-board passenger count of each of the interior areas between the stops. The boarding history information may be generated in accordance with a past on-board passenger count in each of the boarding areas of the cars between the stops. Specifically, the boarding history information may be generated in accordance with, for example, data collected in a specific period in the past. For example, the boarding history information may be obtained either as an average value or as a median value of the on-board passenger count obtained every day in a specific period in the past for each of the interior areas of the cars between the stops. Note that the on-board passenger count may be calculated by any given technique. For example, the on-board passenger count may be calculated in accordance with an image captured by an imaging device installed inside the car. Specifically, a count of people in the image may be automatically calculated by, for example, a computer, and a count of the people between the stops may be determined as the boarding history information between the stops. The boarding history information may be obtained for each interior area.

The boarding history information may be generated for each of all the cars to be operated on the operation schedule. The boarding history information generated for all the cars to be operated on the operation schedule may be associated with each of the cars operated on the operation schedule. That is, each of all the cars to be operated on the operation schedule may have boarding history information generated to be associated with the car.

The history information extracting unit 112 may extract the target car history information in accordance with an operation condition of the target car in operation. In this case, the boarding history information may be generated for each operation condition. The operation condition may include any given condition related to the operation of the cars.

The operation condition may include, for example, calendar information. The calendar information is information on operation dates of a car. For example, the calendar information may include information on days of the week. For example, the calendar information may include information on weekdays or holidays. For example, the calendar information may include information on national holidays. The information processing device 10 can obtain the calendar information either, for example, with reference to the calendar information stored in the storage unit 12, or by receiving the calendar information from an external device.

The operation condition may include, for example, weather information. The weather information is information on weather of a place in which the car is operated. The weather information may include, for example, information as to presence or absence of precipitation and/or snowfall. The weather condition may include, for example, information on the weather such as a sunny day, a cloudy day, or a rainy day. The information processing device 10 can obtain the weather information through, for example, the Internet.

The operation condition may include, for example, information on vacations of educational facilities. The educational facilities may include, for example, at least any of an elementary school, a junior high school, a senior high school, and a university. The information on the vacations of the educational facilities may include information on a vacation of an educational facility to which the students are expected to commute via a station where the car is operated. The information on the vacations of the educational facilities may include, for example, information on long vacations of the educational facilities (e.g., a summer vacation and a winter vacation). The information processing device 10 can obtain the information on the vacations of the educational facilities through, for example, an input made by an administrator of the information processing device 10, an external device, or the Internet.

The operation condition may include, for example, operation status information. The operation status information is information on an operation status of the car. The operation status information may include information on delays, cancelations, and destination changes due to, for example, an accident. The operation status information may include information on arrivals, increases, or decreases of scheduled relief services. The information processing device 10 can obtain the operation status information through, for example, an input made by an administrator of the information processing device 10, an external device, or the Internet.

The operation condition may include at least any one of information on the vacations of the educational facilities, the calendar information, the operation status information, and the weather information. In the example described here, the operation condition includes: information on the vacations of the educational facilities, the calendar information, and the weather information. Specifically, the operation condition here includes: whether an educational facility is in a long vacation period as the information on the vacations of the educational facilities: whether it is a weekday or a holiday as the calendar information, and whether it is a sunny day or a rainy day as the weather information. Note that the operation condition shall not be limited to the information on the vacations of the educational facilities, the calendar information, and the weather information. The operation condition may include other conditions.

As described above, the boarding history information may be generated for each operation condition. For example, as to the information on the vacations of the educational facilities, which is one of the operation conditions, the boarding history information may be generated to include boarding history information in a long vacation period (i.e., a day in the long vacation period) and boarding history information out of the long vacation period (i.e., a day out of the long vacation period). Likewise, as to the calendar information, which is one of the operation conditions, the boarding history information may be generated to include weekday boarding history information and holiday boarding history information. Likewise, as to the weather information, which is one of the operation conditions, the boarding history information may be generated to include sunny-day boarding history information and rainy-day boarding history information.

If a plurality of the operation conditions are found, the boarding history information may be generated for all the combinations of the operations conditions. For example, the boarding history information may be generated for all the combinations of the three operation conditions such as the information on the vacations of the educational facilities, the calendar information, and the weather information. Hence, in the example here, eight items of the boarding history information may be generated as follows:
1. in long vacation, weekday, and sunny day;
2. in long vacation, weekday, and rainy day;
3. in long vacation, holiday, and sunny day;
4. in long vacation, holiday, and rainy day;
5. out of long vacation, weekday, and sunny day;
6. out of long vacation, weekday, and rainy day;
7. out of long vacation, holiday, and sunny day; and
8. out of long vacation, holiday, and rainy day.

The boarding history information for each of the combinations is generated for each of the cars to be operated on the operation schedule, and stored in, for example, the storage unit 12.

At Step S22, the history information extracting unit 112 extracts, from the boarding history information, boarding history information directed to the target car and matching an operation condition. The extracted boarding history information serves as the target car history information. For example, the history information extracting unit 112 extracts operation conditions of a day on which a passenger get on the target car. Specifically, the history information extracting unit 112 obtains information as to whether the date on which the passenger gets on the target car is in a long vacation period of an educational facility, through information stored in the storage unit 12, an external device, or the Internet. Furthermore, the history information extracting unit 112 obtains information as to whether the day on which the passenger gets on the target car is either a weekday or a holiday, from a calendar stored in the storage unit 12. Moreover, the history information extracting unit 112 obtains information as to whether the day on which the passenger gets on the target car is either a sunny day or a rainy day, through the Internet. As can be seen, the history information extracting unit 112 obtains the operation conditions. Then, the history information extracting unit 112 extracts (obtains), from the storage unit 12, boarding history information: included in the boarding history information associated with cars to be operated on the same operation schedule as that of the car identified by the car identifying unit 111; and matching the obtained operation conditions. The boarding history information serves as the target car history information. For example, if the operating conditions are “within long vacation period, weekday, and sunny day” the history information extracting unit 112 extracts, from the storage unit 12, boarding history information: included in the boarding history information associated with cars to be operated on the same operation schedule as that of the car identified by the car identifying unit 111; and directed to the operation conditions of “in long vacation period, weekday, and sunny day”. The extracted boarding history information indicates, for the car to be operated on the same operation schedule as that of the identified car, a past on-board passenger count for each of the interior areas between the stops on a day under the operation conditions of “in long vacation period, weekday, and sunny day”. The passenger count of a car varies depending on operation conditions. Hence, the past on-board passenger count indicated in the boarding history information might vary for each of the operation conditions. For example, the past on-board passenger count on a sunny day might be larger than the past on-board passenger count on a rainy day.

In accordance with the target car history information extracted at Step S22, the congestion information generating unit 113 generates congestion information on each interior area from the departure station to the destination station of the target car (Step S23).

Described here with reference to FIG. 4 is an example of specific processing executed by the congestion information generating unit 113 at Step S23. FIG. 4 is a flowchart showing an example of processing executed by the congestion information generating unit 113. That is, FIG. 4 is a flowchart showing the details of Step S23 in FIG. 3.

First, the congestion information generating unit 113 obtains boarding-and-alighting passenger count information on a boarding-and-alighting passenger count for each of the boarding doors at the stops, including the departure station, from the departure station to the destination station of the target car, using the target car history information extracted at Step S22 (Step S31). In this example, assumed is a case where there are two stops, namely, Station B and Station C between Station A, the departure station, and Station D, the destination station. In this case, the congestion information generating unit 113 obtains boarding-and-alighting passenger count information on each of the boarding doors at Stations A, B, and C, using the target car history information.

The boarding-and-alighting passenger count information can be calculated by various techniques. For example, in accordance with the target car history information, the congestion information generating unit 113 may calculate an increase or a decrease of the boarding-and-alighting passenger count as the boarding-and-alighting passenger count information. For example, when calculating an increase or a decrease of the boarding-and-alighting passenger count at Station A, the congestion information generating unit 113 calculates, with reference to the target car history information, a difference between: an on-board passenger count in an interior area between Station A and Station B that is the next stop; and an on-board passenger count in the interior area between a previous stop of Station A and Station A. The calculated difference indicates an increase or a decrease of the on-board passenger count found in the interior area of the target car when the passengers get on and off the target car at Station A. If the on-board passenger count in the interior area decreases when the passengers gets on and off the car at Station A, the calculated difference is a negative value. As can be seen, the congestion information generating unit 113 can calculate an increase or a decrease of the boarding-and-alighting passenger count at Station A as the boarding-and-alighting passenger count information. The congestion information generating unit 113 obtains the boarding-and-alighting passenger count information for each of the interior areas. Each of the interior areas is associated with one of the boarding doors. Hence, the boarding-and-alighting passenger count information can be used as an index associated with the boarding door.

For example, if an on-board passenger count in a specific interior area is 20 between Station A and Station B, and the on-board passenger count in the specific interior area is 18 between the previous stop of Station A and Station A, the boarding-and-alighting passenger count information on the specific interior area represents +2. This shows that, because the passengers get on and off the car at Station A, the on-board passenger count increases by two in the specific interior area. Whereas, for example, if the on-board passenger count in a specific interior area is 20 between Station A and Station B, and the on-board passenger count in the specific interior area is 22 between the previous stop of Station A and Station A, the boarding-and-alighting passenger count information on the specific interior area represents −2. This shows that, because the passengers get on and off the car at Station A, the on-board passenger count decreases by two in the specific interior area.

As another technique, for example, the congestion information generating unit 113 may calculate an increase rate or a decrease rate of the boarding-and-alighting passenger count as the boarding-and-alighting passenger count information, in accordance with the target car history information. For example, when calculating an increase rate or a decrease rate of the boarding-and-alighting passenger count at Station A, the congestion information generating unit 113 calculates, with reference to the target car history information, a rate of an on-board passenger count in an interior area between Station A and Station B to an on-board passenger count in the interior area between the previous stop of Station A and Station A. The calculated rate indicates an increase or a decrease of the on-board passenger count obtained for the interior area of the target car when the passengers get on and off the target car at Station A. If the calculated rate is larger than 1, the rate shows that the passengers get on more than get off at Station A, and if the calculated rate is smaller than 1, the rate shows that the passengers get off more than get on at Station A. As can be seen, the congestion information generating unit 113 can calculate the rate of the boarding-and-alighting passenger count at Station A as the boarding-and-alighting passenger count information. The congestion information generating unit 113 obtains the boarding-and-alighting passenger count information for each of the interior areas.

For example, if an on-board passenger count in a specific interior area is 24 between Station A and Station B, and the on-board passenger count in the specific interior area is 20 between the previous stop of Station A and Station A, the boarding-and-alighting passenger count information on the specific interior area represents 1.2. This shows that, because the passengers get on and off the car at Station A, the on-board passenger count increases by 20% in the specific interior area. Whereas, for example, if the on-board passenger count in the specific interior area is 16 between Station A and Station B, and the on-board passenger count in the specific interior area is 20 between the previous stop of Station A and Station A, the boarding-and-alighting passenger count information on the specific interior area represents 0.8. This shows that, because the passengers get on and off the car at Station A, the on-board passenger count in the specific interior area decreases by 20% in the specific interior area.

As can be seen, the congestion information generating unit 113 can calculate the boarding-and-alighting passenger count information for each of the boarding doors at the stops.

Next, the congestion information generating unit 113 obtains the on-board passenger count in an interior area associated with each of the boarding doors of the target car, at a time point when the target car arrives at Station A, the departure station (Step S32). Here, the interior area associated with each of the boarding doors may be previously associated with the boarding door. For example, if one car is provided with only one boarding door, an interior of the car provided with the boarding door may be determined as the interior area associated with the boarding door.

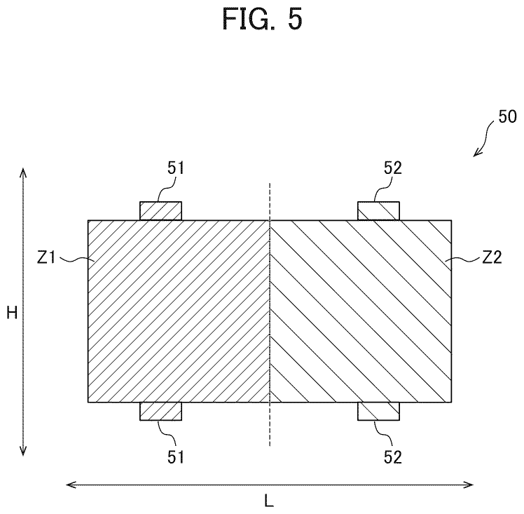

For example, if one car is provided with two boarding doors fore and aft, an interior of the car may be divided into two areas, and the two areas may be determined as the interior areas each associated with one of the two boarding doors. Specifically, as schematically illustrated, for example, in FIG. 5, assume one car 50 is provided with two boarding doors; namely a boarding door 51 and a boarding door 52 in a longitudinal direction L. In the example illustrated in FIG. 5, a pair of boarding doors provided in a lateral direction H of the car 50 is interpreted as one boarding door. In the longitudinal direction L of the car 50, a pair of boarding doors closest to one end is referred to as a first boarding door 51, and a pair of boarding doors closest to another end is referred to as a second boarding door 52. In such a case, the whole area of the car 50 may be divided into two in the longitudinal direction L, and a first region Z1 either including the first boarding door 51 or adjacent to the first boarding door 51 may be determined as an area associated with the first boarding door 51. Likewise, a second region Z2 either including the second boarding door 52 or adjacent to the second boarding door 52 may be determined as an area associated with the second boarding door 52.

In a case where three or more boarding doors are provided to one car, interior areas associated with the respective boarding doors may be determined by the same technique described above. The interior areas are preferably close to the respective boarding doors. For example, when a passenger who gets on a car at a boarding door stays in an area, the area is preferably determined as the interior area associated with the boarding door.

At Step S32, the congestion information generating unit 113 may obtain the on-board passenger count of an interior area by various techniques. For example, the congestion information generating unit 113 determines, in accordance with the target car history information, an on-board passenger count of an interior area between the previous stop of Station A and Station A as the on-board passenger count of the interior area, thereby successfully obtaining the on-board passenger count of the interior area.

The congestion information generating unit 113 calculates a boarding-and-alighting passenger count between the stations of the target car from the departure station to the destination station, in accordance with the boarding-and-alighting passenger count information obtained at Step S31 and the on-board passenger count obtained at Step S32 for the interior area (Step S33). For example, here, the congestion information generating unit 113 calculates the on-board passenger count for each of the interior areas between Station A and Station B, between Station B and Station C, and between Station C and Station D.

For example, first, the congestion information generating unit 113 calculates the on-board passenger count between Station A and Station B, in accordance with: the on-board passenger count of each of the interior areas obtained at Step S32 when the target car arrives at Station A; and the boarding-and-alighting passenger count information obtained on Station A at Step S31. For example, if the boarding-and-alighting passenger count information is obtained in accordance with an increase or a decrease of passengers, the congestion information generating unit 113 adds the increase or the decrease of the passengers to the on-board passenger count obtained for each of the interior areas when the target car arrives at Station A, thereby successfully calculating the on-board passenger count between Station A and Station B. Alternatively, for example, if the boarding-and-alighting passenger count information is calculated in accordance with an increase rate or a decrease rate of passengers, the congestion information generating unit 113 multiplies the increase rate or the decrease rate of the passengers by the on-board passenger count obtained for each of the interior areas when the target car arrives at Station A, thereby successfully calculating the on-board passenger count between Station A and Station B.

Here, the congestion information generating unit 113 calculates the on-board passenger count between Station A and Station B for each of the interior areas. For example, with reference to FIG. 5, the congestion information generating unit 113 can calculate the on-board passenger count for each of the first region Z1 and the second region Z2 between Station A and Station B.

Next, the congestion information generating unit 113 calculates the on-board passenger count for each of the interior areas between Station B and Station C. For example, the on-board passenger count is calculated in the same manner as the on-board passenger count for each of the interior areas between Station A and Station B. Here, when calculating the on-board passenger count between Station B and Station C, the congestion information generating unit 113 can use the on-board passenger count between Station A and Station B, as calculated above. That is, the congestion information generating unit 113 applies the boarding-and-alighting passenger count information to the on-board passenger count between Station A and Station B as calculated above, in order to calculate the on-board passenger count between Station B and Station C.

Likewise, the congestion information generating unit 113 calculates the on-board passenger count for each of the interior areas between Station C and Station D. As can be seen, the congestion information generating unit 113 can calculate the on-board passenger count for each of the interior areas of the target car between the stations from Station A to Station D.

The congestion information generating unit 113 calculates the on-board passenger count for each of the interior areas of the target car between the stops, and then, generates congestion information on each interior area from the departure station to the destination station (Step S34). The congestion information generating unit 113 may generate congestion information on each of the interior areas throughout the departure station to the destination station. That is, in this example, the congestion information generating unit 113 may generate congestion information on each of the interior areas throughout the departure station to the destination station. In this case, the congestion information generating unit 113 generates the congestion information not for each of the sections between the stations from Station A to Station D, but the whole section throughout Station A to Station D. In this case, the congestion information generating unit 113 may generate, as the congestion information, an average congestion degree indicating an average of congestion degrees for each of the interior areas of the target car from the departure station (Station A) to the destination station (Station D). Alternatively, the congestion information generating unit 113 may generate, as the congestion information, a maximum congestion degree indicating a maximum value of the congestion degrees for each of the interior areas of the target car from the departure station (Station A) to the destination station (Station D). That is, the congestion information generated by the congestion information generating unit 113 may include at least one of the average congestion degree or the maximum congestion degree.

At Step S34, the congestion information generating unit 113 does not necessarily generate the congestion information for each of the interior areas only from the departure station to the destination station. For example, the congestion information generating unit 113 may generate the congestion information for each of the interior areas also between the stops from the departure station to the destination station.

Note that the congestion information is information indicating the degree of congestion, and the congestion information generating unit 113 can generate the congestion information with any given index and by any given technique that allow the passengers to understand the congestion degree. For example, the congestion information generating unit 113 can use the on-board passenger count for each of the interior areas directly as a numerical value indicating the congestion information. In this case, a higher numerical value can be understood to indicate a more crowded interior area. Alternatively, for example, the congestion information generating unit 113 can use a capacity rate of a car as the congestion information. The capacity rate is calculated in accordance with the on-board passenger count for each of the interior areas. The capacity rate is a rate of an on-board passenger count in a car to an authorized capacity of the car. In this case, a higher numerical value can be understood to indicate a more crowded interior area.

The congestion information generating unit 113 may generate the congestion information in predetermined levels. For example, the congestion information generating unit 113 may generate the congestion information in three levels; that is, “NOT CONGESTED”, “SLIGHTLY CONGESTED”, and “CONGESTED”. The congestion information generating unit 113 may determine to which one of the three levels each of the interior areas corresponds, in accordance with the on-board passenger count of each interior area. For example, if the on-board passenger count in an interior area is smaller than a first threshold value, the congestion information generating unit 113 may classify the congestion information on the interior area as “NOT CONGESTED”. For example, if the on-board passenger count in an interior area is larger than, or equal to, the first threshold value and smaller than a second threshold value (note that the second threshold is larger than the first threshold value), the congestion information generating unit 113 may classify the congestion information on the interior area as “SLIGHTLY CONGESTED”. For example, if the on-board passenger count in an interior area is equal to, or larger than, the second threshold value, the congestion information generating unit 113 may classify the congestion information on the interior area as “CONGESTED”. Note that the congestion information does not have to be necessarily classified into the three levels of “NOT CONGESTED”, “SLIGHTLY CONGESTED”, and “CONGESTED”. The congestion information may be classified into any given levels.

Note that the congestion information generating unit 113 may generate the congestion information also on sections between the stations from the departure station to the destination station of the target car. The congestion information generating unit 113 may generate the congestion information on each of the interior areas at least throughout the departure station to the destination station.

As can be seen, the control unit 11 can execute the congestion information generation processing. The congestion information generation processing generates the congestion information on each of the interior areas of the target car from the departure station to the destination station.

As described with reference to FIG. 2, the generated congestion information is transmitted from the information processing device 10 to the terminal device 20. Upon receiving the congestion information, the terminal device 20 may display the congestion information on the display unit 24.

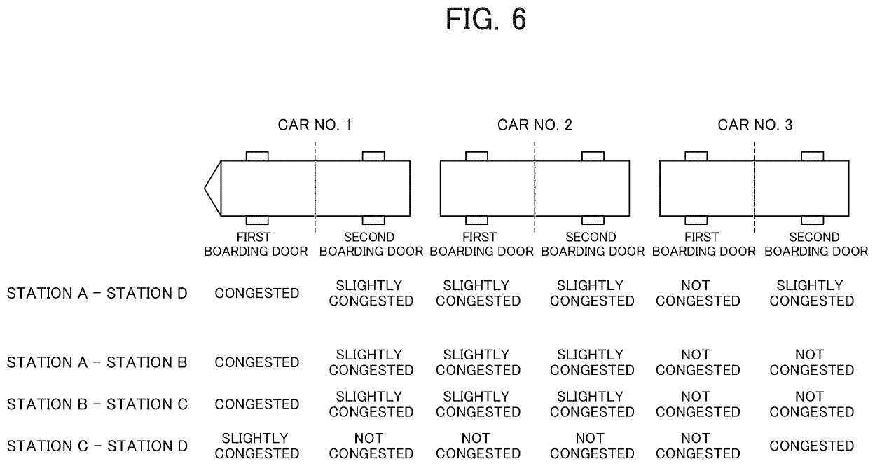

FIG. 6 is a diagram illustrating an example of the congestion information displayed on the display unit 24 of the terminal device 20. In the example illustrated in FIG. 6, the congestion information is displayed in the three levels of “NOT CONGESTED”, “SLIGHTLY CONGESTED”, and “CONGESTED”. In the example illustrated in FIG. 6, a schematic diagram is illustrated to show target cars that a passenger gets on. FIG. 6 illustrates three target cars from Car No. 1 to Car No. 3. However, the target cars may be displayed in any given manner. All the cars serving as the target cars may be displayed. Furthermore, the display unit 24 may omit displaying the schematic illustration of the target cars.

In the example illustrated in FIG. 6, all the cars from Car No. 1 to Car No. 3 are each provided with two boarding doors; namely, the first boarding door and the second boarding door. The boarding doors are associated with the respective interior areas of each car. The display unit 24 displays the congestion information in the three levels for each of the interior areas from the departure station (Station A) to the destination station (Station D). In the example illustrated in FIG. 6, the congestion information is displayed as follows: an interior area associated with the first boarding door of Car No. 1 is “CONGESTED”, an interior area associated with the second boarding door of Car No. 1 is “SLIGHTLY CONGESTED”, an interior area associated with the first boarding door of Car No. 2 is “SLIGHTLY CONGESTED”, an interior area associated with the second boarding door of Car No. 2 is “SLIGHTLY CONGESTED”, an interior area associated with the first boarding door of Car No. 3 is “NOT CONGESTED”, and an interior area associated with the second boarding door of Car No. 3 is “SLIGHTLY CONGESTED”. A passenger who sees such a display understands that, for example, the first boarding door of Car No. 3 would be least congested. Hence, the passenger gets on Car No. 3 at the first boarding door, thereby successfully avoiding congestion when he or she gets on the car.

As illustrated in FIG. 6, the display unit 24 may further display the congestion information between the stations from Station A to Station D. For example, when the congestion information generating unit 113 generates at Step S34 the congestion information on each of the interior areas between the stops from the departure station to the destination station, the display unit 24 may display the congestion information between the stops. As can be seen, the congestion information between the stations is displayed, so that the passenger can obtain the congestion information between the stations.

As can be seen, for a target car that the passenger gets on, the information processing device 10 generates the congestion information on the interior areas associated with the respective boarding doors from the departure station to the destination station. The passenger checks the congestion information, thereby successfully getting in an interior area of the target car with low congestion degree. Hence, when the passenger gets on the target car that he or she is to use, the passenger can get in an interior area with low congestion degree. Thus, the passenger of the car readily avoids congestion without changing the car to get on. For example, even if the target car that the passenger is to use is relatively congested, the passenger can get in an interior area of the car with low congestion degree.

Furthermore, the information processing device 10 can generate congestion information from the departure station to the destination station, thereby successfully generating congestion information on a section in which the passenger is on the target car. For example, with reference to the example in FIG. 6, “NOT CONGESTED” is displayed for both of the interior areas each associated with one of the first boarding door and the second boarding door of Car No. 3 between Station A and Station B. However, between Station C and Station D, “NOT CONGESTED” is displayed for the interior area associated with the first boarding door of Car No. 3; whereas, “CONGESTED” is displayed for the interior area associated with the second boarding door of Car No. 3. For example, if Station C has an aisle and a stairway leading to a ticket gate near the second boarding door of Car No. 3, many passengers get on Car No. 3 at the second boarding door. These many passengers might cause congestion of the interior area associated with the second boarding door of Car No. 3 at Station C and subsequent stations. If the information processing device 10 generates the congestion information with reference only to information on the departure from Station A, the determination “NOT CONGESTED” could be made for both of the interior areas each associated with one of the first boarding door and the second boarding door of Car No. 3. However, in this embodiment, the information processing device 10 generates the congestion information in accordance with a congestion degree of the entire section, in which the passenger is on the target car, from Station A to Station D. Hence, the passenger can get in an interior area that is relatively less congested throughout the section of the target car.

The congestion information generation system 1 according to the above embodiment is described to include the terminal device 20 as an external display device. However, the external display device included in the congestion information generation system 1 does not have to be necessarily the terminal device 20. The external display device may be any given device capable of displaying the congestion information received from the information processing device 10.

For example, the external display device may be a ticket vending machine installed in a station. In this case, the ticket vending machine includes a display unit; that is, a well-known display such as an LCD, an OELD, or an IELD. The display unit displays the congestion information. Specifically, assume a case where a passenger purchases a ticket on the ticket vending machine to get on a car. In this case, the passenger performs an operational input on the ticket vending machine for purchasing a ticket to a destination station (Step S11 in FIG. 2). Here, the ticket vending machine can determine the departure station, the destination station, and the time point information.

Specifically, the ticket vending machine may determine a station where the ticket vending machine is installed as the departure station. This is because the passenger purchases a ticket to get on a car at a station where the ticket vending machine is installed.

Furthermore, the ticket vending machine may determine the destination station in accordance with an input by the passenger. For example, the ticket vending machine may determine the destination station of the purchased ticket as the destination station of the passenger. This is because the passenger would possibly use the purchased ticket to move on the car. Here, for example, if a fare (a price of the ticket) is determined in stages according to distance, that is, if a fare is determined on the basis of mileage, a plurality of stations may be found within a range in which the passenger can travel with the purchased ticket. In this case, the ticket vending machine may determine, as destination stations, all of the plurality of stations found within the range in which the passenger can travel with the purchased ticket. Furthermore, for example, if cars are operated in a plurality of directions from a station where the ticket vending machine is installed, (e.g., if inbound cars and outbound cars are operated), the ticket vending machine may determine, as destination stations for all of the plurality of directions, all of the plurality of stations found within the range in which the passenger can travel with the purchased ticket.

Moreover, the ticket vending machine may determine a time point of purchase of the ticket as the time point information. This is because the passenger would possibly use the car immediately after he or she has purchased the ticket.

Then, in accordance with the operational input performed by the passenger for purchasing the ticket, the ticket vending machine requests the information processing device 10 for congestion information (Step S12 in FIG. 2). Here, the departure station, the destination station, and the time point information are transmitted to the information processing device 10.

The information processing device 10 executes the congestion information generation processing, using the departure station, the destination station, and the time point information received from the ticket vending machine (Step S13 in FIG. 2). The details of the congestion information generation processing are the same as those described above, and will not be elaborated upon here.

The information processing device 10 transmits the generated congestion information to the ticket vending machine (Step S14 in FIG. 2). Then, the ticket vending machine displays the received congestion information on the display unit (Step S15 in FIG. 2). When purchasing the ticket on the ticket vending machine, the passenger checks the congestion information displayed as described above on the ticket vending machine. Hence, the passenger can obtain the congestion information on each of the interior areas associated with one or a plurality of boarding doors from the departure station to the destination station.

Note that, as described above, if a plurality of destination stations are found, the ticket vending machine may display the congestion information on each of all the destination stations from the departure station. Alternatively, the ticket vending machine may display the congestion information on each of at least some of the destination stations from the departure station.

The external display device does not have to be a ticket vending machine. For example, the external display device may be an information display device installed in a station. The information display device may be a platform display that displays information such as, for example, a departure time point, a destination, and a type of a train. In this embodiment, the information display device includes a display unit; that is, a well-known display such as, for example, an LCD, an OELD, or an IELD. The display unit displays the congestion information.

If the external display device is an information processing device installed in a station, the information display device may request the information processing device 10 for congestion information without receiving an operational input from a passenger. That is, Step S11 in FIG. 2 may be omitted, and Step S12 in FIG. 2 may be executed. The information display device may request the information processing device 10 for congestion information, for example, periodically; that is, at regular intervals of time.

In this case, the information display device may determine the station in which the information display device is installed as the departure station. Furthermore, when a car departs from a station in which the information display device is installed, the information display device may determine a station at which the car stops afterward as the destination station. Here, if the car, which departs from the station in which the information display device is installed, stops at a plurality of stations afterward, the information display device may determine some or all of the plurality of stations as destination stations. That is, when the car departs from the station in which the information display device is installed, the information display device may determine some or all of the stations at which the car stops afterward as destination stations. Moreover, the information display device determines a current time point as the time point information.

When requesting the information processing device 10 for congestion information, the information display device may transmit to the information processing device 10 the departure station, the destination station, and the time point information described above.

The information processing device 10 executes the congestion information generation processing, using the departure station, the destination station, and the time point information received from the information display device (Step S13 in FIG. 2). The details of the congestion information generation processing are the same as those described above, and will not be elaborated upon here.

The information processing device 10 transmits the generated congestion information to the information display device (Step S14 in FIG. 2). Then, the information display device displays the received congestion information on the display unit (Step S15 in FIG. 2). Here, the information display device may display some or all of the congestion information from the departure station to the plurality of destination stations. For example, assume a case where the information display device is installed in Station A. The car departing from Station A stops at Station B, Station C, Station D, and Station E in the stated order. In this case, the information display device may display some or all of the congestion information from Station A to Station B, the congestion information from Station A to Station C, the congestion information from Station A to Station D, and the congestion information from Station A to Station E. In a case where only some of the congestion information is displayed, the information display device may display congestion information on a station having many boarding and alighting passengers and designated as the destination station. If the information display device cannot display all of the congestion information up to the plurality of destination stations at once on the display unit, the information display device may, for example, scroll and display all of the congestion information up to the plurality of destination stations.

The passenger checks the information display device at a station, thereby successfully obtaining the congestion information up to his or her destination station.

Note that if an external display device is the information display device, the information display device itself does not have to request the information processing device 10 for the congestion information. That is, Step S12 in FIG. 2 may be omitted. In this case, for example, the information processing device 10 may set a specific station (e.g., Station A) as the departure station, a station at which the car departing from the departure station stops as the destination station, and a current time point as the time point information, in accordance with, for example, an operation schedule, and may execute the congestion information generation processing. Then, the information processing device 10 may transmit the generated congestion information to an information display device installed in the specific station (e.g., Station A). The information display device displays the obtained congestion information. Hence, the information display device can provide the congestion information to the passengers.

In the congestion information generation system 1, the external display device may include at least any one or more of: the terminal device 20 used by a passenger, a ticket vending machine installed in the departure station, and an information display device installed in the departure station. The external display device shall not be limited to the examples here. The external device may be another device.

In addition, for example, if the external display device is a ticket vending machine, the destination station may be determined in accordance with an input by the passenger as described above. As can be seen in this example, at least one of the departure station or the destination station may be determined in accordance with an input by the passenger. As seen in the case where the external display device is the terminal device 20, both the departure station and the destination station may be determined in accordance with an input by the passenger.

### Second Embodiment

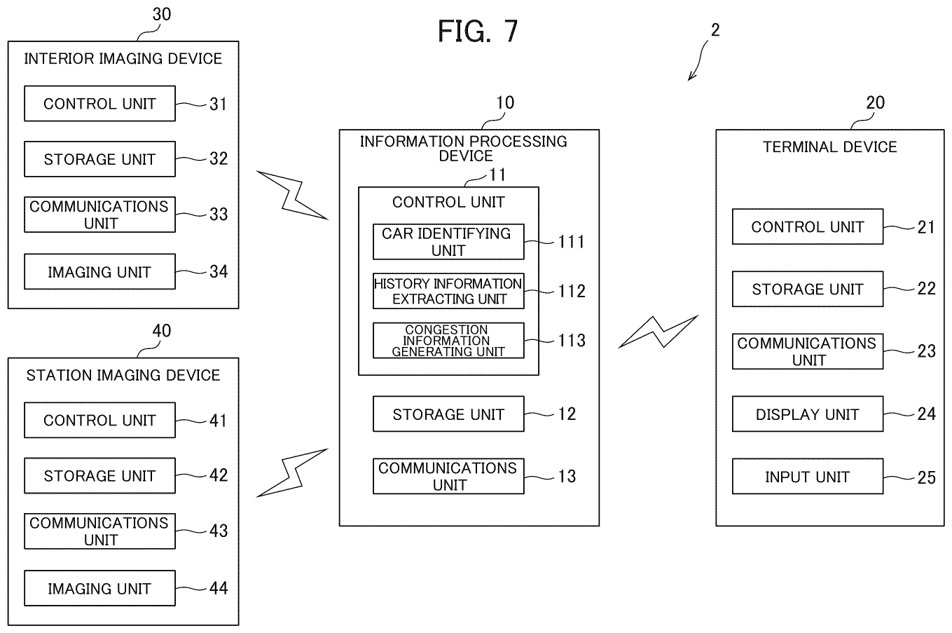

FIG. 7 is a functional block diagram illustrating a schematic configuration of a congestion information generation system 2 according to a second embodiment. As illustrated in FIG. 7, the congestion information generation system 2 according to the second embodiment includes: the information processing device 10; a terminal device 20; an interior imaging device 30; and a station imaging device 40. The information processing device 10 is communicably connected to the terminal device 20, the interior imaging device 30, and the station imaging device 40 so as to exchange information through, for example, wire communications or wireless communications. The congestion information generation system 2 according to the second embodiment will be described mainly on the differences from the congestion information generation system 1 according to the first embodiment, while common features between the congestion information generation system 2 and the congestion information generation system 1 will be omitted as appropriate.

The information processing device 10 and the terminal device 20 included in the congestion information generation system 2 according to the second embodiment may be the same in configuration as the information processing device 10 and the terminal device 20 included in the congestion information generation system 1 according to the first embodiment. Hence, here, detailed descriptions will be omitted for the configurations of the information processing device 10 and the terminal device 20.

The interior imaging device 30 is an imaging device installed in an interior of a car. The interior imaging device 30 may be installed in, for example, all cars in operation. Hence, even though FIG. 7 illustrates only one interior imaging device 30, the congestion information generation system 2 actually includes a plurality of the interior imaging devices 30, and the plurality of interior imaging devices 30 are installed in the respective cars. The plurality of interior imaging devices 30 may be installed in the cars so that all of the plurality of interior imaging devices 30 capture altogether all the interior areas of all the cars in operation. For example, one or the plurality of interior imaging devices 30 may be installed for one car or for one interior area.

The interior imaging device 30 obtains a still image or a moving image. The interior imaging device 30 may be, for example, a camera. The interior imaging device 30 may be, for example, a depth camera including a depth sensor that obtains depth information. As illustrated in FIG. 7, the interior imaging device 30 includes: a control unit 31; a storage unit 32, a communications unit 33; and an imaging unit 34.

The control unit 31 controls and manages the whole interior imaging device 30 including the functional units of the interior imaging device 30. The control unit 31 runs, for example, an information processing program stored in the storage unit 32 to carry out various kinds of control. For example, the control unit 31 can be such a control device as a CPU or an MPU. The control unit 31 obtains an image, using, for example, the imaging unit 34.

The storage unit 32 is a storage medium capable of storing programs and data. The storage unit 32 can be, for example, a semiconductor memory or a magnetic memory. Specifically, the storage unit 32 can be, for example, an EEPROM. The storage unit 32 may store, for example, a program for operating the control unit 31. The storage unit 32 may store at least a portion of the image obtained by at least the interior imaging device 30. The image stored in the storage unit 32 may be automatically erased after a predetermined time period has elapsed.

The communications unit 33 executes communications, and exchanges information, with an external device. In this embodiment, the communications unit 33 executes communications, and exchanges information, with, for example, the information processing device 10. The communications unit 33 may execute communications, and exchange information, through, for example, wire communications or wireless communications. The communications unit 33 transmits and receives various kinds of information through communications. For example, in this embodiment, the communications unit 33 transmits to the information processing device 10 an image obtained by the interior imaging device 30.

The imaging unit 34 includes at least an optical system and an imaging element. When a subject image is formed on a light-receiving surface of the imaging element through the optical system, the imaging element converts the subject image into an image signal to obtain an image. Examples of the imaging element may include such sensors as a charge coupled device (CCD) image sensor and a complementary metal oxide semiconductor (CMOS) image sensor.

The station imaging device 40 is an imaging device installed in a station. The station imaging device 40 is installed in any given position from which passengers can be captured when getting on and off a car at the station. For example, the station imaging device 40 may be installed on, for example, a roof or a ceiling of a platform of the station. The station imaging device 40 may be installed in, for example, all of the stations. Hence, even though FIG. 7 illustrates only one station imaging device 40, the congestion information generation system 2 actually includes a plurality of the station imaging devices 40, and the plurality of station imaging devices 40 are installed in the respective stations. The plurality of station imaging devices 40 may be installed in the stations so that all of the plurality of station imaging devices 40 capture whole platforms of all the stations at which the car stops. For example, one or the plurality of the station imaging devices 40 may be installed in each station.

The station imaging device 40 obtains a still image or a moving image. The station imaging device 40 may be, for example, a camera. The station imaging device 40 may be, for example, a depth camera including a depth sensor that obtains depth information. As illustrated in FIG. 7, the station imaging device 40 includes: a control unit 41; a storage unit 42, a communications unit 43; and an imaging unit 44.

The station imaging device 40 may be the same in configuration as the interior imaging device 30. That is, the control unit 41, the storage unit 42, the communications unit 43, and the imaging unit 44 included in the station imaging device 40 may be respectively the same in configuration as the control unit 31, the storage unit 32, the communications unit 33, and the imaging unit 34 included in the interior imaging device 30. Hence, here, detailed description will be omitted for the specific configurations of the control unit 41, the storage unit 42, the communications unit 43, and the imaging unit 44.

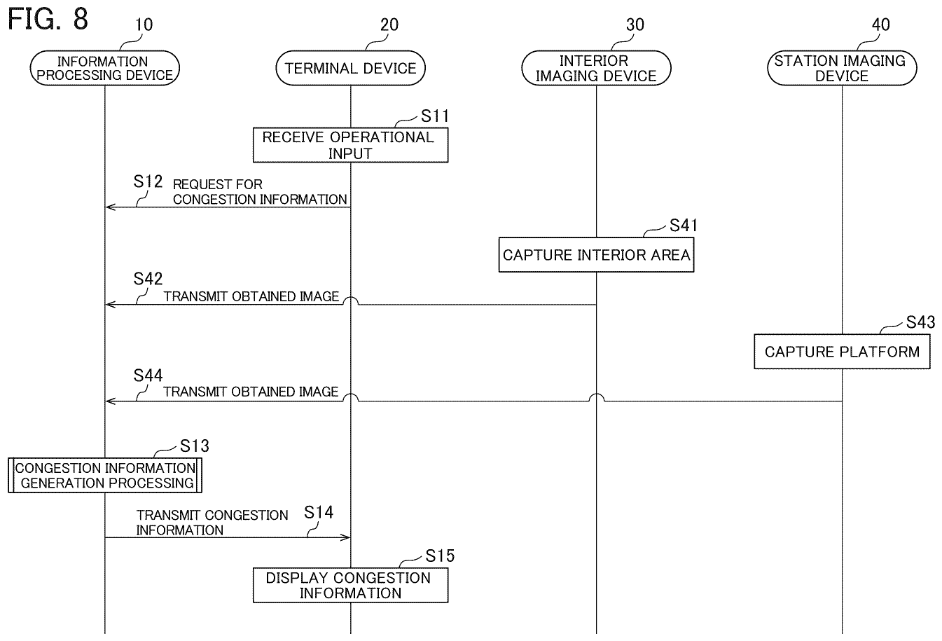

FIG. 8 is a sequence diagram showing an example of processing carried out by the congestion information generation system 2 in FIG. 7.

When a passenger would like to check the congestion information, he or she carries out a predetermined operational input to the terminal device 20 using the input unit 25. The terminal device 20 receives the operational input carried out by the passenger (Step S11). Here, as can be seen in the first embodiment, the terminal device 20 may receive inputs of, for example, the departure station, the destination station, and the time point information. In accordance with the operational input by the passenger, the terminal device 20 transmits, to the information processing device 10, a signal for requesting for congestion information (Step S12). The details of Step S11 and Step S12 may be the same as those in FIG. 2.

Upon receiving, from the terminal device 20, a signal requesting for the congestion information, the information processing device 10 receives obtained images from the interior imaging device 30 and the station imaging device 40.

Specifically, the information processing device 10 executes Step S21 out of the processing described with reference to FIG. 3 in order to identify a target car, and receives an image obtained by the interior imaging device 30 installed in the target car. Furthermore, the information processing device 10 receives an image obtained by the station imaging device 40 installed in the departure station.

For example, the interior imaging device 30 installed in the target car captures an interior area, using the imaging unit 34 (Step S41). The interior imaging device 30 may either always or periodically capture the interior area.

The interior imaging device 30 transmits the obtained image to the information processing device 10 (Step S42). The interior imaging device 30 may either always or periodically transmit the obtained image to the information processing device 10. In this case, the information processing device 10 may store the received image in the storage unit 12 in association with the interior imaging device 30. That is, the information processing device 10 stores the image in the storage unit 12 in an identifiable state where the image stored in the storage unit 12 is obtained by which interior imaging device 30.

Alternatively, when receiving, from the information processing device 10, the request for transmitting an image, the interior imaging device 30 may transmit the image to the information processing device 10. In this case, the information processing device 10 identifies the interior imaging device 30 of the target car, and transmits a request for transmission of the image to the identified interior imaging device 30. Upon receiving, from the information processing device 10, the request for transmitting the image, the interior imaging device 30 transmits the image to the information processing device 10.

Furthermore, for example, the station imaging device 40 installed in the departure station captures a platform of the station, using the imaging unit 44 (Step S43). The station imaging device 40 may either always or periodically capture the platform.

The station imaging device 40 transmits the obtained image to the information processing device 10 (Step S44). The station imaging device 40 may either always or periodically transmit the obtained image to the information processing device 10. In this case, the information processing device 10 may store the received image in the storage unit 12 in association with the station imaging device 40. That is, the information processing device 10 stores the image in the storage unit 12 in an identifiable state where the image stored in the storage unit 12 is obtained by which station imaging device 40.

Alternatively, when receiving, from the information processing device 10, the request for transmitting an image, the station imaging device 40 may transmit the image to the information processing device 10. In this case, the information processing device 10 transmits a request, for transmitting the image, to the station imaging device 40 installed in the departure station. Upon receiving, from the information processing device 10, the request for transmitting the image, the station imaging device 40 transmits the image to the information processing device 10.

Preferably, the image received by the information processing device 10 is obtained at a time point closer to the time point at which the target car arrives at the departure station. That is, preferably, the image received by the information processing device 10 is obtained immediately before a passenger gets on the target car at the departure station. This is because the congestion information can be generated, reflecting more accurately the actual interior area and state of the station observed when the passenger is about to get on the target car.

Upon receiving the images from the interior imaging device 30 and the station imaging device 40, the information processing device 10 executes the congestion information generation processing, using the received images (Step S13).

Specifically, the information processing device 10 identifies the target car (Step S21 in FIG. 3), and obtains target car history information that matches an operation condition (Step S22 in FIG. 3). Note that, if the information processing device 10 has identified the target car before receiving the image from the interior imaging device 30, the information processing device 10 may omit Step S21 in the congestion information generation processing.

Then, the information processing device 10 generates the congestion information on each of the interior areas from the departure station to the destination station (Step S23 in FIG. 3). Here, the information processing device 10 can generate the congestion information, using the images received from the interior imaging device 30 and the station imaging device 40. Specifically, the congestion information generating unit 113 of the information processing device 10 may: calculate an on-board passenger count for each of the interior areas of the target car in accordance with the image obtained by the interior imaging device 30 provided in the target car; and generate the congestion information in accordance with the on-board passenger count. Furthermore, the congestion information generating unit 113 may: calculate a count of passengers getting on the target car at the departure station for each of the boarding doors of the target car, in accordance with the image obtained by the station imaging device 40 provided to the departure station; and generate the congestion information in accordance with the count of the passengers getting on the target car at the departure station. Processing to be executed by the congestion information generating unit 113 in this case will be described in detail with reference to FIG. 4 again.

First, boarding-and-alighting passenger count information is obtained for each of the boarding doors of the target car at each of the stops (Step S31).

Next, the congestion information generating unit 113 obtains an on-board passenger count for each of the interior areas at a time point at which the target car arrives at the departure station (Step S32). Here, the congestion information generating unit 113 may calculate the on-board passenger count for each of the interior areas of the target car, in accordance with an image obtained by the interior imaging device 30. That is, the congestion information generating unit 113 calculates the on-board passenger count for each of the interior areas of the target car, using the image obtained at Step S42. The congestion information generating unit 113 calculates a count of passengers in the image by a known technique, thereby successfully calculating the on-board passenger count for each of the interior areas. Here, when the image is obtained on a real-time basis from the interior imaging device 30, the congestion information generating unit 113 can carry out a real-time calculation of a current on-board passenger count for each of the interior areas. Such a feature improves accuracy of the congestion information to be generated.

Then, the congestion information generating unit 113 calculates the on-board passenger counts between the stations from the departure station to the destination station (Step S33). Here, the congestion information generating unit 113 may calculate a count of passengers boarding at the departure station for each of the boarding doors of the target car, in accordance with the images obtained by the station imaging device 40 provided to the departure station. In the example here, the congestion information generating unit 113 may calculate a count of passengers getting on the target car at Station A, from the images obtained by the station imaging device 40 provided to Station A. The congestion information generating unit 113 may determine a count of passengers at a platform of Station A as a count of passengers getting on the target car at Station A. The congestion information generating unit 113 calculates a count of passengers in the image by a known technique, thereby successfully calculating a count of passengers at the platform. Here, the congestion information generating unit 113 may further determine at which boarding door each of the passengers gets on the target car, in accordance with positions of the passengers in the image. For example, the congestion information generating unit 113 may determine a boarding door, closest to the position of each passenger in the image, as the boarding door to be used when the passenger gets on the target car.

The congestion information generating unit 113 determines the count of passengers calculated in this manner as a count of passengers getting on the target car at Station A. Using the determined count of passengers getting on the target car at Station A, the congestion information generating unit 113 calculates the on-board passenger count between Station A and Station B. For example, the congestion information generating unit 113 corrects the boarding-and-alighting passenger count obtained at Step S31, in accordance with the calculated count of passengers, and calculates the on-board passenger count between Station A and Station B, using the corrected boarding-and-alighting passenger count information. Specifically, the congestion information generating unit 113 can determine how much larger or smaller the calculated count of passengers is than a count of passengers boarding at Station A and indicated in the past history, and can correct the boarding-and-alighting passenger count information in accordance with a result of the determination. For example, if the calculated count of passengers is larger than a count of passengers boarding at Station A and indicated in the past history, the congestion information generating unit 113 increases either a count of passengers or an increase rate of passengers indicated as the boarding-and-alighting passenger count information, thereby successfully correcting the boarding-and-alighting passenger count information. In contrast, if the calculated count of passengers is smaller than a count of passengers boarding at Station A and indicated in the past history, the congestion information generating unit 113 decreases either the count of passengers or the increase rate of passengers indicated as the boarding-and-alighting passenger count information, thereby successfully correcting the boarding-and-alighting passenger count information.

After calculating the on-board passenger count between Station A and Station B, the congestion information generating unit 113 calculates the on-board passenger counts between Station B and Station C and between Station C and Station D by the same technique as described in the first embodiment. Hence, the congestion information generating unit 113 calculates the on-board passenger counts between the stations from the departure station to the destination station.

Then, in accordance with the on-board passenger counts calculated at Step S33, the congestion information generating unit 113 generates congestion information (Step S34).

Then, the information processing device 10 transmits the generated congestion information to the terminal device 20 (Step S14), and the terminal device 20 displays the received congestion information on the display unit 24 (Step S15).

The congestion information generation system 2 according to the second embodiment can generate the congestion information, using the images obtained by the interior imaging device 30 and the station imaging device 40. The images obtained by the interior imaging device 30 and the station imaging device 40 reflect the situations of the interior areas and the platform on the moment when the images are obtained. Hence, thanks to these images, the actual operating situation of the target car that the passengers get on can be reflected more accurately on generation of the congestion information. For example, if a difference is large between the actual passenger count of the target car and the passenger count indicated in the boarding history information, the accuracy decreases of the congestion information based only on the boarding history information. However, the images obtained by the interior imaging device 30 and the station imaging device 40 are used, such that the congestion information is generated in accordance with the situation of the date on which the target car is in operation. As a result, the accuracy of the congestion information improves.

The second embodiment describes a case where the congestion information generating unit 113: calculates a count of passengers boarding at the departure station for each of the boarding doors of the target car, in accordance with the image obtained by the station imaging device 40 provided to the departure station; and generates the congestion information in accordance with a count of passengers boarding at the departure station. However, the congestion information generating unit 113 does not necessarily have to use the image alone obtained by the station imaging device 40 provided to the departure station. For example, the congestion information generating unit 113 may further use images obtained by the station imaging devices 40 provided to the respective stops between the departure station and the destination station. In this case, the congestion information generating unit 113 may: calculate a count of passengers at each of the stops, using the images obtained by the station imaging devices 40 provided to the respective stations; and correct the boarding-and-alighting passenger count information between the stops in accordance with the calculated count of passengers. Such a feature allows for reflecting the actual situation of each of the stops on the date and time when the target car operates, thereby making it possible to further improve accuracy of the congestion information.

Furthermore, the second embodiment describes a case where the congestion information generating unit 113 obtains images from both the interior imaging device 30 and the station imaging device 40. However, the congestion information generating unit 113 may obtain images from either the interior imaging device 30 or the station imaging device 40 to generate the congestion information. In this case, also, the congestion information can be generated, using the images obtained at least one of the interior imaging device 30 or the station imaging device 40. Such a feature can improve the congestion information.

Moreover, the images obtained by the interior imaging device 30 and the station imaging device 40 described in the second embodiment do not have to be necessarily used only when the congestion information is generated. For example, the images obtained by the interior imaging device 30 and the station imaging device 40 described in the second embodiment may be used for generating the boarding history information. That is, the images obtained by the interior imaging device 30 and the station imaging device 40 may be used for collecting information on: the passenger counts in the interior areas for each of the cars in operation; and the boarding-and-alighting passenger count at each of the stops. In accordance with the information collected in such manners, the boarding history information may be generated by, for example, the information processing device 10.

The first and second embodiments describe a case where the information processing device 10 generates the congestion information, and the terminal device displays the congestion information. However, the congestion information generation system may further encourage the passengers to use a specific boarding door. For example, the information processing device 10 generates the congestion information, and also determines the least congested interior area in accordance with the generated congestion information and identifies a boarding door associated with the determined interior area. The information processing device 10 transmits, to the terminal device 20, information on the identified boarding door together with, or instead of, the congestion information. The terminal device 20 displays, on the display unit 24, the information on the identified boarding door together with, or instead of, the congestion information. Here, the terminal device 20 may present a notification to the passenger and encourage him or her to get on the car at the identified boarding door. For example, the terminal device 20 may display on the display unit 24 a message to encourage the passenger to get on Car No. 3 at the first boarding door, and send the message as a voice output from a not-shown speaker. The passenger following the notification can readily avoid congestion when getting on the car.

In this case, the information processing device 10 identifies a boarding door for one passenger. When the information processing device 10 generates the congestion information next time for another passenger and identifies a boarding door, the information processing device 10 may obtain the boarding-and-alighting passenger count information, using information on the boarding door identified for the first passenger. For example, when the information processing device 10 identifies a boarding door for one passenger, the information processing device 10 determines that the one passenger gets on the car from the identified boarding door at the departure station, and reflects the one passenger on the on-board passenger count of the interior area. That is, in this way, the information processing device 10 adds one more passenger to the on-board passenger count to be calculated in the congestion information generation processing. If another passenger uses, for example, the terminal device 20, and requests the information processing device 10 for the congestion information, the information processing device 10 obtains the boarding-and-alighting passenger count information, using the on-board passenger count including the one passenger for which the boarding door is identified. Furthermore, even if still another passenger requests for the congestion information, the information processing device 10 obtains the boarding-and-alighting passenger count information, using information on the one passenger for which the boarding door is identified and on the boarding door identified for the other passenger. Assume a case where the congestion information is generated without reflecting the information on the boarding door identified for the passenger, and a single boarding door is identified for a plurality of passengers. If the plurality of passengers get on the car at once at the single boarding door, the interior area associated with the boarding door could be consequently congested. However, as described in this paragraph, the congestion information is generated, reflecting the information on the boarding door already identified for the one passenger. As a result, a different boarding door could be identified for each of the passengers. Thanks to such a feature, congestion is less likely to be concentrated on a certain interior area.

The first and second embodiments describe a case where the information processing device 10 generates the congestion information, using the boarding history information. However, the information processing device 10 does not necessarily have to use the boarding history information when generating the congestion information. For example, the information processing device 10 may generate the congestion information using the images alone received from the interior imaging device 30 and the station imaging device 40. In this case, the information processing device 10 generates the congestion information in accordance with the information obtained when the images are obtained. Furthermore, the information processing device 10 may generate the congestion information in accordance with a structure of each of the stops. The structure of each stop may include, for example, a shape and a size of a platform, a location of a ticket gate, and a structure of an aisle including a stairway and an escalator.

The information processing device 10 and the congestion information generation method disclosed in this description are applicable in general to devices and methods for generating congestion information.

### REFERENCE SIGNS LIST

1 Congestion Information Generation System
10 Information Processing Device
11, 21, 31, and 41 Control Unit
12, 22, 32, and 42 Storage Unit
13, 23, 33, and 43 Communications Unit
24 Display Unit
25 Input Unit
30 Interior Imaging Device
34 and 44 Imaging Unit
40 Station Imaging Device
50 Car
51 First Boarding Door
52 Second Boarding Door
111 Car Identifying Unit
112 History Information Extracting Unit
113 Congestion Information Generating Unit
H Lateral Direction
L Longitudinal Direction
Z1 First Region
Z2 Second Region

1. An information processing device, comprising:
a car identifying unit configured to identify a target car that a passenger gets on, in accordance with a departure station and a destination station of the passenger using a car, and with time point information, the car being provided with a plurality of boarding doors; and
a congestion information generating unit configured to generate congestion information indicating a degree of congestion of interior areas each associated with one or a plurality of boarding doors of the target car running from the departure station to the destination station.

2. The information processing device according to claim 1, further comprising
a history information extracting unit configured to extract, from boarding history information, target car history information on the target car, the boarding history information indicating either a past on-board passenger count or a past boarding passenger count between stops of a car in operation,
wherein the congestion information generating unit generates the congestion information in accordance with the target car history information.

3. The information processing device according to claim 2, wherein the congestion information generating unit: obtains boarding-and-alighting passenger count information on a boarding-and-alighting passenger count for each of the boarding doors of the target car at stops from the departure station to the destination station, using the target car history information; and generates the congestion information in accordance with the boarding-and-alighting passenger count information for each of the boarding doors and with an on-board passenger count of passengers on board in each of the interior areas associated with one or the plurality of boarding doors of the target car.

4. The information processing device according to claim 2, wherein the history information extracting unit extracts the target car history information in accordance with an operation condition of the target car in operation.

5. The information processing device according to claim 4, wherein the operation condition includes at least any one of information on vacations of educational facilities, calendar information, operation status information, and weather information.

6. The information processing device according to claim 2, wherein the boarding history information is data generated in accordance with either a past on-board passenger count or a past boarding-and-alighting passenger count in each of boarding areas of cars between the stops.

7. The information processing device according to claim 1, wherein the car identifying unit identifies the target car in accordance with an operation schedule including a time point at which cars depart from each of stations.

8. The information processing device according to claim 1, wherein the congestion information includes at least one of: an average congestion degree indicating an average of congestion degrees for each of the interior areas of the target car from the departure station to the destination station; or a maximum congestion degree indicating a maximum value of the congestion degrees for each of the interior areas of the target car from the departure station to the destination station.

9. The information processing device according to claim 1, wherein the congestion information generating unit: calculates an on-board passenger count for each of the interior areas of the target car in accordance with an image obtained by an interior imaging device provided in the target car; and generates the congestion information in accordance with the on-board passenger count.

10. The information processing device according to claim 1, wherein the congestion information generating unit: calculates a count of passengers getting on the target car at the departure station for each of the boarding doors of the target car, in accordance with an image obtained by a station imaging device provided to the departure station; and generates the congestion information in accordance with the count of the passengers getting on the target car at the departure station.

11. The information processing device according to claim 1, further comprising a communications unit configured to transmit the congestion information to an external display device.

12. The information processing device according to claim 11, wherein the external display device includes at least any one or more of a terminal device used by the passenger, a ticket vending machine installed in the departure station, and an information display device installed in the departure station.

13. The information processing device according to claim 1, wherein the time point information is determined in accordance with an input by the passenger.

14. The information processing device according to claim 1, wherein at least one of the departure station or the destination station is determined in accordance with an input by the passenger.

15. A congestion information generation method executed by an information processing device, the congestion information generation method comprising:
a step of identifying a target car that a passenger gets on, in accordance with a destination station and a departure station of the passenger using a car, and with time point information, the car being provided with a plurality of boarding doors; and
a step of generating congestion information indicating a degree of congestion of interior areas each associated with one or a plurality of boarding doors of the target car running from the departure station to the destination station.
